(19) United States
(12) Patent Application Publication
(10) Pub. No.: US 2008/0119960 A1
(43) Pub. Date: May 22, 2008

(54) Method and System for Avoiding Collisions Between Moveable Devices

(76) Inventors: Francois Beaulieur, Paris (FR); Vincent Brach, Le Kremlin Bicetre (FR); Jean-Claude Billebaut, Vitry sur Seine (FR)

Correspondence Address: YOUNG & THOMPSON, 745 SOUTH 23RD STREET, 2ND FLOOR, ARLINGTON, VA, 22202, US

(21) Appl. No.: 11/632,657

(22) PCT Filed: Jul. 19, 2004
(86) PCT No.: PCT/FR04/01905

§ 371 Date: Mar. 14, 2007

(51) Int. Cl. G05B 19/4061; B25J 9/16; G08B 7/00

(52) U.S. Cl. 700/255; 340/384.1; 340/815.4

(57) ABSTRACT

A method for avoiding collisions between at least two physical entities consisting of elements definable by points which can be known in a digital form. The points can be displaced simultaneously according to at least one degree of freedom. Each of the simultaneous displacements requires a minimum variation in the corresponding degree of freedom prior to stopping. A computer-type system is used to store and process the points in digital form. The deformable digital model is defined inside the computer-type system for each of the elements of the physical entitites. The deformable model contains the positions which the points of the associated element can assume during any particular combination of simultaneous displacements according to the degrees of freedom during minimum variations prior to stopping.

This invention relates in a general way to machines for avoiding collisions, and more specifically to a process and a system for avoiding collisions that make it possible to avoid collisions between at least two movable machines.

The worksite machines such as the cranes or the lifting machines are well known in the art. In a worksite such as a building worksite, these machines are implemented to make transport possible, from one point to the next of the worksite, of raw materials such as concrete or construction elements. In a site such as a dockside of a port, loading cranes are used to load and to unload freight onto and from ships and, in a general way, movable machines are used to move loads to industrial sites.

All of these types of machines usually comprise several degrees of freedom that are combined with one another to allow access to one part or another of the site. Usually, a certain number of machines are necessary to allow access to the entire site. However, to allow the transport over the entire worksite, the zones that accessible by the various machines should have common parts. This presents the drawback that in these common parts, the loads that are transported by the machines and/or certain elements of the machines may collide with one another.

Consequently, safety devices are used to try to avoid such collisions to the extent possible.

However, the devices of the prior art are limited at present to performing proximity detections using sensors such as devices for detecting proximity by ultrasound, etc., or by exchanging information that makes it possible to detect a risk of collision on the basis of static positions of the machines or the load thereof.

These devices have various drawbacks including the cost of the proximity sensors that are to equip all the elements that are in motion. Likewise, these various sensors should be connected by cables to an acquisition center, which is expensive in terms of labor. In addition, the reliability of the unit decreases as the number of cables and connectors increases.

Furthermore, the fact of detecting the risk of collision on the sole basis of the static positions offers various drawbacks. For example, if two machines are in the process of moving away from one another after being too close to one another, most of the current devices will continue to generate an alarm, although in fact the devices are in the process of moving away. This has the result of operating said machines in a degraded so-called “safety” operating mode, which slows down their operation. In addition, this will also have the result that an alarm will be essentially pointless for half of its duration, with the annoyances, for example auditory annoyances, that this involves.

Also, the majority of the devices that operate on the basis of static positions will have a tendency to generate unnecessarily an alarm on the basis of static safety margins that do not take into account the dynamic specificities of the various elements that are able to begin to collide.

The repetition of mis-timed alarms presents the drawback of a fast acclimatization of the operators to these alarms, with the risk that a real alarm, wrongly considered as mis-timed by an operator, is ignored by the latter, with the consequences that are possible to imagine.

Furthermore, the mis-timed alarms present the drawback of uselessly distracting the attention of the drivers of the machines, with the risk that another problem, although real, remains unnoticed, because the attention of the driver or drivers concerned is focused on a nonexistent problem.

Consequently, there is a need for a process and a system for avoiding collisions that make it possible to more finely evaluate the actual risk of a collision by taking into account the direction of movement and the corresponding stopping distances of the various elements of the lifting machines before setting off a risk of collision alarm.

More specifically, this invention has as its object a process for avoiding collisions between at least two physical entities, said at least two physical entities consisting of elements, said elements being defined by points, said points being able to be known in digital form, said points being able to move simultaneously according to at least one degree of freedom, each of said simultaneous movements requiring a minimum variation of said corresponding degree of freedom prior to stopping, a computer-type system being used to store and to process said points in digital form, said at least one computer-type system making it possible to store and to process said points in digital form and which has for a characteristic the fact that a deformable digital model is defined inside said computer-type system for each of said elements of said physical entities, said deformable model containing all of the positions that the points of said associated element are able to assume during any combination of simultaneous movements according to said at least one degree of freedom during said minimum variations prior to stopping, said computer-type system calculating, for at least one entity, a distance between each of said deformable models of the elements of said at least one entity and each of said deformable models of the elements of the same entity or another entity, said computer-type system detecting a risk of collision when at least one of said distances is less than a predefined safety distance.

In the process of the invention, said physical entities can be, for example, machines that can be used in a shop, on a worksite of construction, of public works or of materials handling, or a port zone.

Preferably, each of said physical entities will comprise a computer-type system, said at least one computer-type system will usually comprise at least one display device making it possible to display said deformable models for an operator.

In addition, an alarm will be generated in general by said at least one computer-type system during said detection of said risk of collision, whereby said alarm can be, for example, audible or visual. Said alarm preferably will be intended for at least one of the operators of said machines.

In the process of the invention, said minimum variations prior to stopping can be determined or measured by said at least one computer system, and in this case, they can be assigned to a predefined value where it is impossible to determine or to measure said minimum variations prior to stopping.

The process of the invention allows the use of two-dimensional deformable models, or, as a variant, three-dimensional deformable models. In this latter case, said deformable models can be approximated by an encompassing prismatic volume that is obtained as the set of points through which a base that consists of a surface element travels during a movement not included in said surface. Said base can then be flat and, in particular, its contour can be defined by a set of connected segments of a line and arcs. Furthermore, which said movement can be rectilinear and, in particular, it can be perpendicular to the plane of said base.

Preferably, in the process of the invention, at least two computer-type systems will be used to process said points in digital form, and more particularly, a computer-type system will be associated with each of said physical entities. Said at least two computer-type systems can then exchange data in digital form, preferably a computer-type means of communication. In general, said computer-type information means will be a computer-type network.

In the process of the invention, said at least one computer-type system can also exert control on the variation of at least one degree of freedom of at least one of said at least two physical entities. For example, said control can consist of a cutoff of the variation of said at least one degree of freedom, or, as a variant, said control can consist of a reduction of the rate of variation of said at least one degree of freedom. In this case, in which said reduction of speed may be inversely proportional to one of said distances between said physical entities.

In the process of the invention, a simple overall envelope can also be defined in said computer-type system for each of said at least two physical entities, whereby two of said at least two physical entities are determined as being unable to collide if their simple overall envelopes present an empty intersection.

In this case, said simple overall envelope will preferably be a prism that is obtained by movement of a basic surface along a path, whereby said basic surface is usually flat, for example a circular disk. Said path will then be, in general, rectilinear and perpendicular to said flat base.

Preferably, in the process of the invention, at least one of said at least one computer-type system will comprise a non-volatile memory, whereby said non-volatile memory then allows the storage in digital form of the configuration of at least one of said entities, whereby said non-volatile memory is usually a computer hard disk.

The invention also proposes a system for avoiding collisions between at least two physical entities, said at least two physical entities consisting of elements, said elements being defined by points, said points being able to be known in digital form, said points being able to move simultaneously according to at least one degree of freedom, each of said simultaneous movements requiring a minimum variation of said corresponding degree of freedom prior to stopping, a computer-type system being used to store and to process said points in digital form, said at least one computer-type system making it possible to store and to process said points in digital form, and which has for a characteristic the fact that it implements the process of the invention.

A preferred embodiment of the invention will now be described, solely by way of example, by referring to the accompanying drawings, in which:

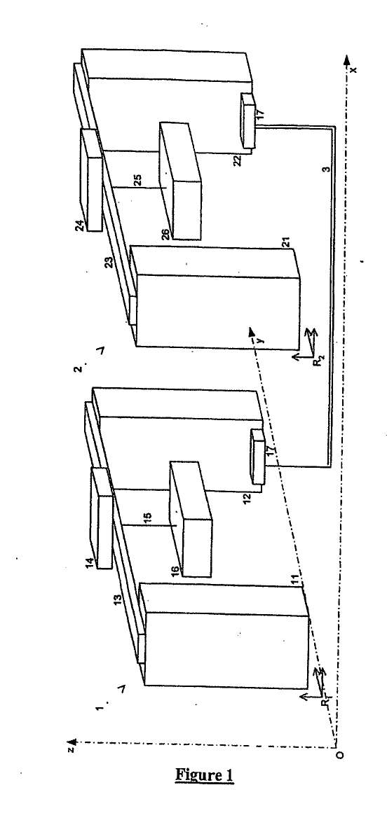

FIG. 1 shows an example of two gantry cranes at a worksite that implements the process of the invention;

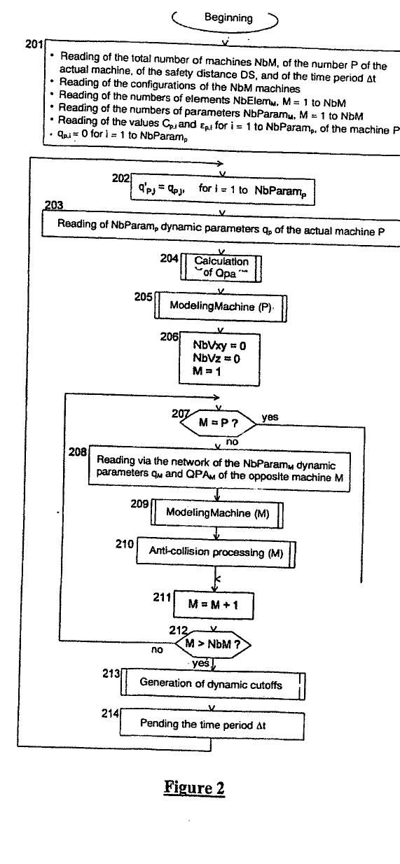

FIG. 2 shows the general flow chart of the program that implements the process of the invention in one of the computer systems of FIG. 1;

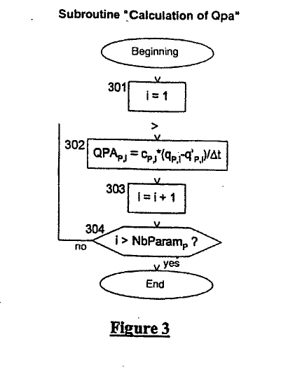

FIG. 3 shows the flow chart of the subroutine “CalculQpa [Calculation of QPA]” that appears in step 204 of FIG. 2;

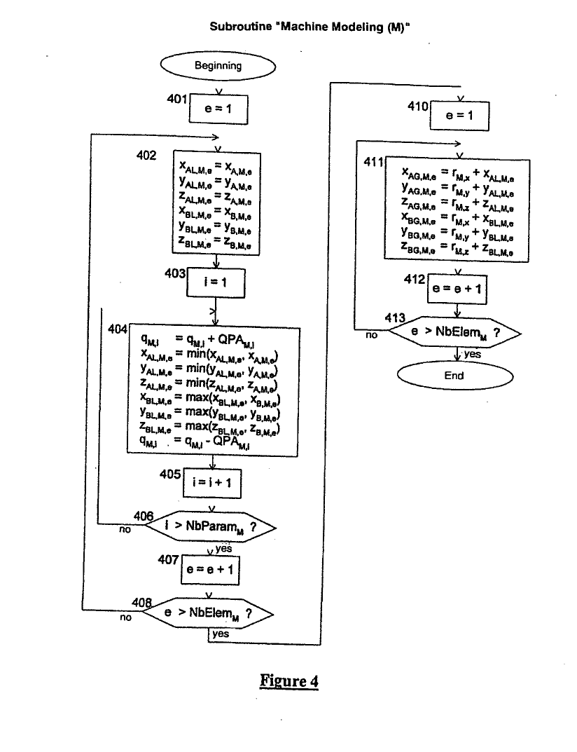

FIG. 4 shows the flow chart of the subroutine “ModelisationEngin [Machine Modeling]” that appears in steps 205 and 209 of FIG. 2;

FIG. 5 shows the flow chart of the subroutine “TraitementAnticollision [Anti-Collision Processing]” that appears in step 210 of FIG. 2;

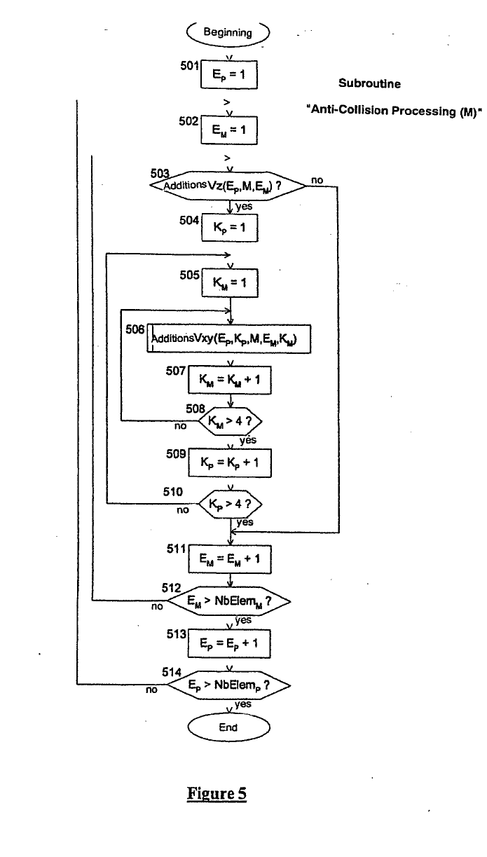

FIG. 6 shows the flow chart of the function “AjoutsVz [Additions of Vz]” that appears in step 503 of FIG. 5;

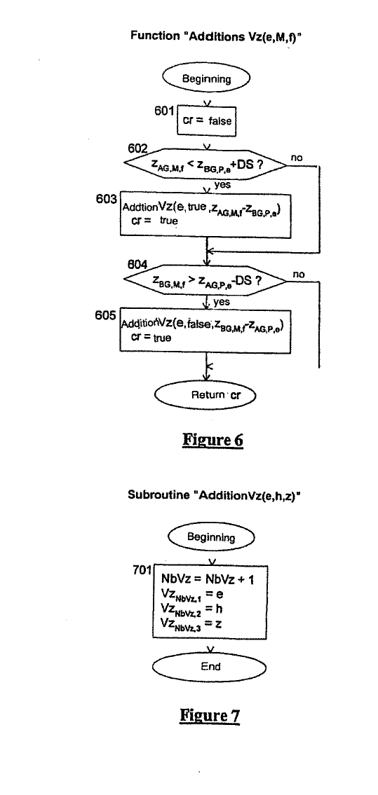

FIG. 7 shows the flow chart of the function “AjoutVz [Addition of Vz]” that appears in steps 603 and 605 of FIG. 6;

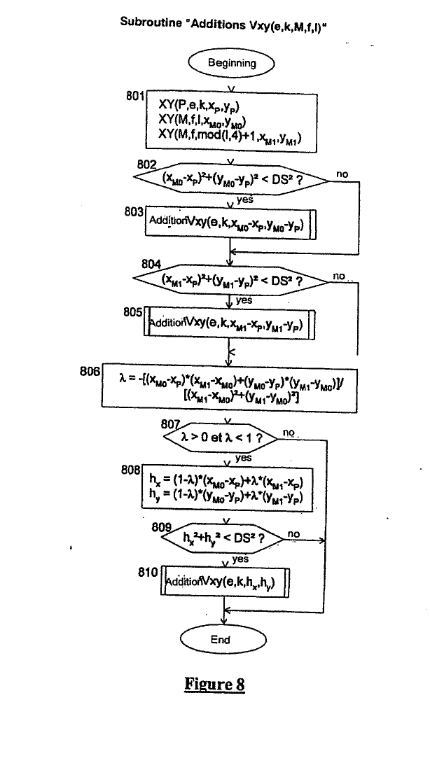

FIG. 8 shows the flow chart of the subroutine “AjoutsVxy [Additions of Vxy]” that appears in step 506 of FIG. 5;

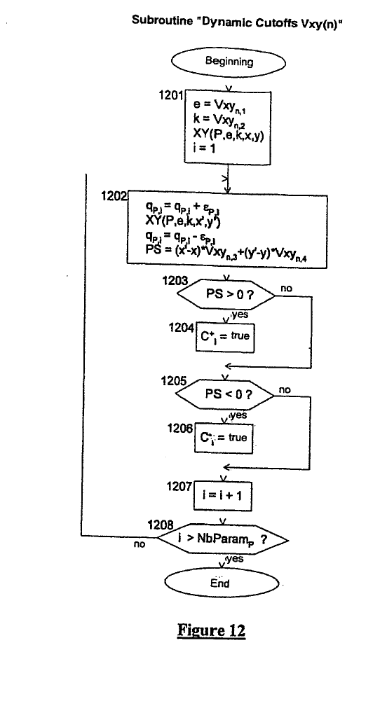

FIG. 9 shows the flow chart of the subroutine “XY” that appears in step 801 of FIG. 8 and in step 1201 of FIG. 12;

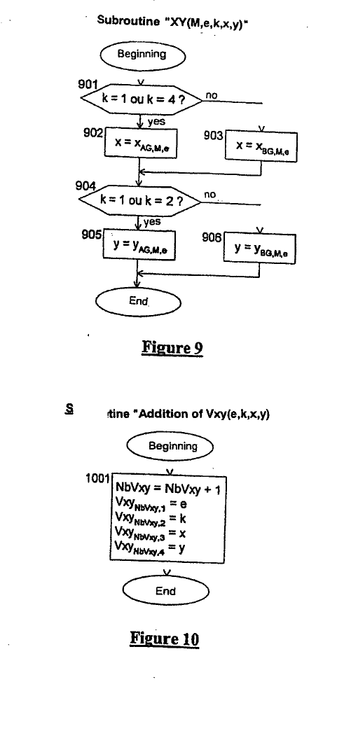

FIG. 10 shows the flow chart of the subroutine “AjoutVxy [Addition of Vxy]” that appears in steps 803, 805 and 810 of FIG. 8;

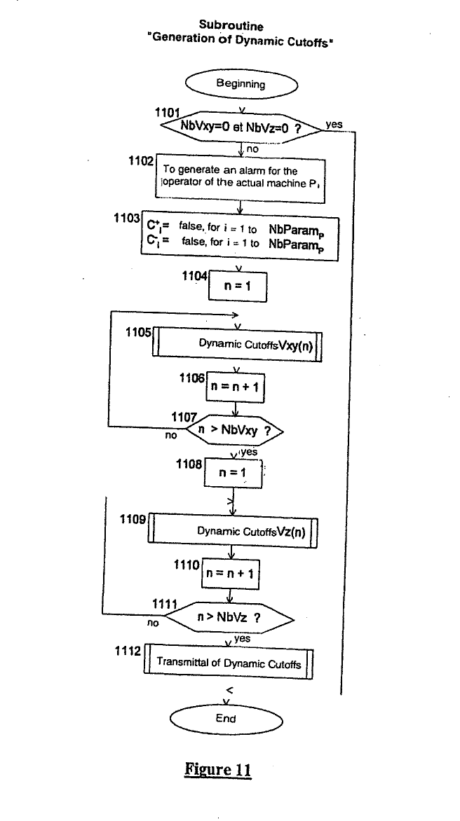

FIG. 11 shows the flow chart of the subroutine “GenerationCoupuresDynamiques [Generation of Dynamic Cutoffs]” that appears in step 213 of FIG. 2;

FIG. 12 shows the flow chart of the subroutine “CoupuresDynamiquesVxy [Dynamic Cutoffs Vxy]” that appears in step 1105 of FIG. 11;

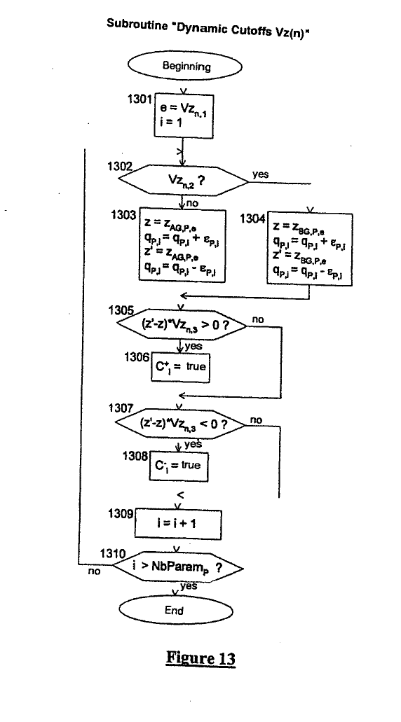

FIG. 13 shows the flow chart of the subroutine “CoupuresDynamiquesVz [Dynamic Cutoffs Vz]” that appears in step 1109 of FIG. 11;

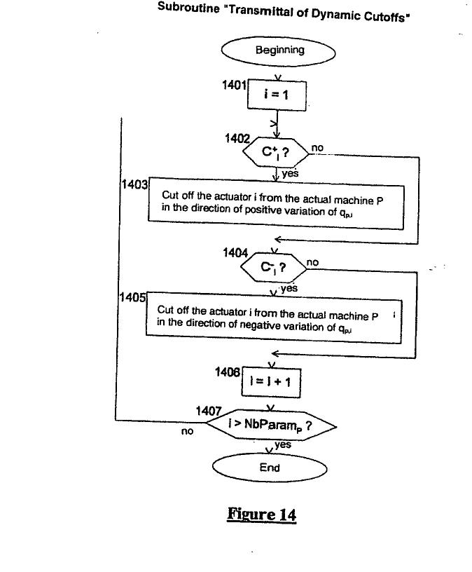

FIG. 14 shows the flow chart of the subroutine “EnvoiCoupuresDynamiques [Transmittal of Dynamic Cutoffs]” that appears in step 1112 of FIG. 11;

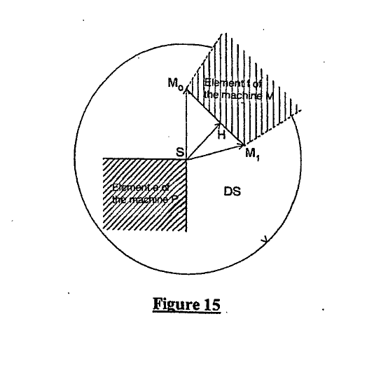

FIG. 15 shows the anti-collision vectors in the XY plane combined at one point of one of the elements of the machines of FIG. 1;

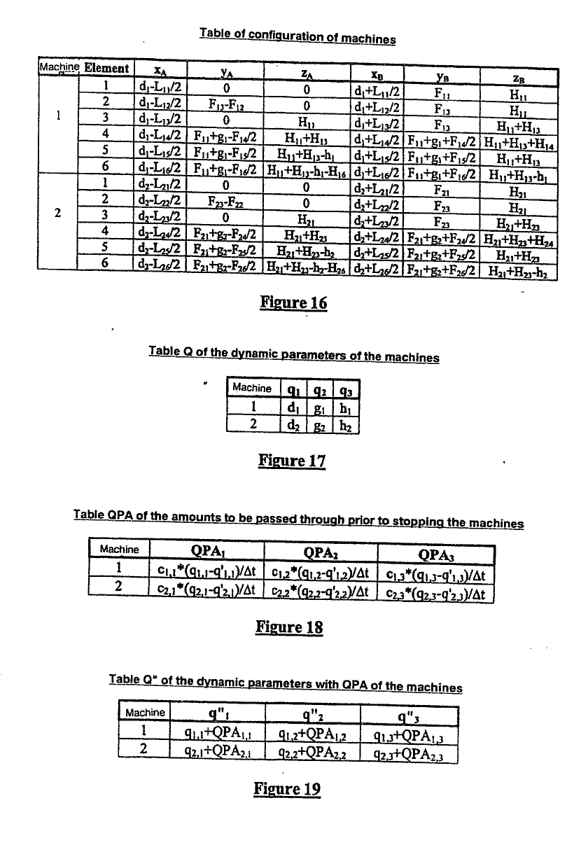

FIG. 16 shows the table of configurations of machines of FIG. 1;

FIG. 17 shows the Table Q of the dynamic parameters of the machines of FIG. 1;

FIG. 18 shows the table of QPA combined with the dynamic parameters of FIG. 17;

FIG. 19 shows the table “Q” of the dynamic parameters with QPA of the machines of FIG. 1;

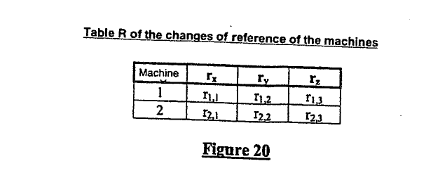

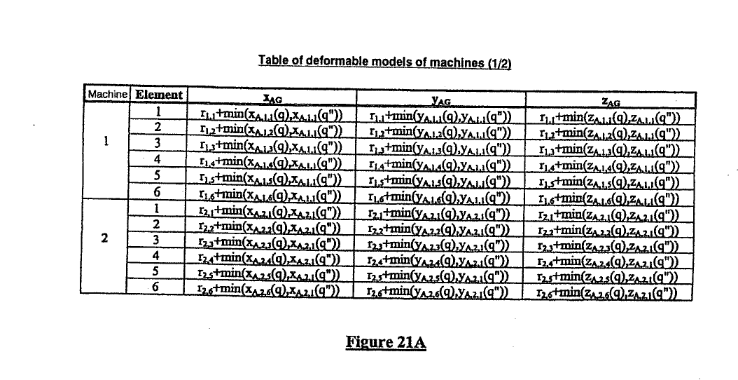

FIG. 20 shows the table R of changes of reference for the machines of FIG. 1;

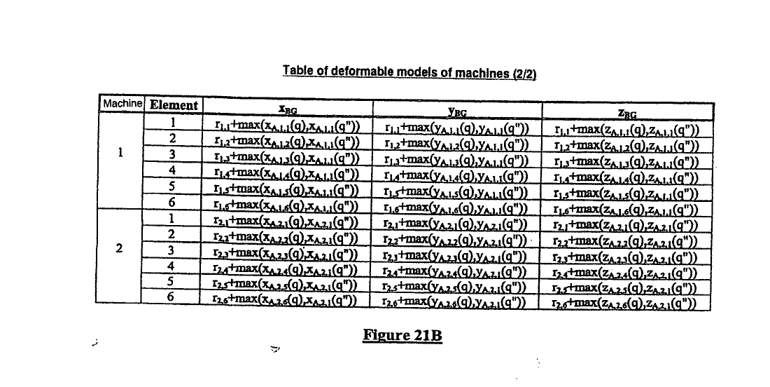

FIGS. 21A and 21B show the table of deformable models of elements of machines of FIG. 1.

In the example presented, the two machines that are used have a vertical plane of symmetry that is parallel to the YZ plane of the overall reference. Consequently, this plane was selected as having the zero abscissa in the local reference point of the machine being considered. Furthermore, the XZ plane is that of the proximal face of the elements 11, 21 of the machines 1, 2, and the XY plane is the common plane of the lower faces of the elements 11, 12, 21, 22.

Furthermore, the elements of the machines 1, 2 consist of parallelepipeds that are defined by two diagonally opposed points A_{M} and BM for the machine of number “M,” whereby the points A and B are respectively the points of smaller and larger coordinates in the reference point of the machine “M” that is concerned.

The dimensions of these parallelepipedic elements along the axes x, y and z are respectively denoted, when they are constant, as L_{Me}, F_{M,e}, H_{M,e}, where “M” represents the number of the machine in question, and “e” represents the number of the element that is considered of the machine “M.”

The dynamic parameters for positioning the machine “M” are denoted as d_{M}, g_{M} and h_{M}, and they are stored in the line “M” of the “Table Q of the Dynamic Parameters of the Machines” shown in FIG. 17. They respectively represent, for the machine M, the distance from the plane of symmetry of the machine to the XY plane of the overall reference, the distance from the cable 15, 25 of the machine “M” to the first pillar 11, 21 of the machine “M,” and the unwound length of the cable 15, 25. These parameters change over time to the extent that the machines 1, 2 are moved on the worksite.

The presence of a parameter d, g_{M} or h, in an expression of the table of FIG. 16, indicates that the corresponding coordinate will vary based on the parameter that is indicated during movements of the machine “M” in question.

By referring more particularly to FIG. 2, the general flow chart of the program implementing the process of the information in the computer system 17 associated with the crane 1 will be described.

The program implementing the process of the invention begins in step 201.

In step 201, the computer 17 re-reads from its non-volatile memory the total number of machines “NbM” that are present on the worksite, the number “P” of the machine in which it is executed, the minimum safety distance “DS” between the elements of the machines 1, 2 below which a risk of collision will be detected, of the period of time “At” between two successive readings of the dynamic parameters of the machines 1, 2 and the parameters of configuration of the “NbM” machines.

Within the scope of the example presented where the computer implementing the process of the invention is the computer 17 associated with the machine 1, the variable P will have the value 1.

The configuration parameters of the “NbM” machines 1, 2 thus re-read are stored in the “Table for Configuration of Machines” shown in FIG. 16. The eight columns of this table respectively contain the number of the machine, the number of the element in the machine, the abscissa, the ordinate and the side of the first point A of the diagonal that defines the element, and the abscissa, the ordinate and the side of the second point B of the diagonal that defines the element.

The computer 17 also re-reads the number of elements “NbElem_{M}” and the number of dynamic parameters “NbParam” of each machine “M.”

The computer 17 also re-reads “NbParam,” “c” values that will be described in relation to FIG. 3. The computer 17 also re-reads “NbParam_{P}” values “ε_{P}” representing increments associated with “NbParam_{P}” parameters of the machine “M,” increments that will be described in relation to FIG. 12.

Then, the computer 17 initializes at 0 the “NbParam,” dynamic parameters “q_{P}” of the machine “P” that it controls. The computer 17 then moves on to step 202.

In step 202, the computer 17 saves the NbParam, current values of the dynamic parameters “q,” of the machine “P.” These values, stored in the line of number “P” of the “Table Q of the Dynamic Parameters of Machines” shown in FIG. 17, are recopied in the corresponding positions of the line of number “P” of “Table Q’ of the Preceding Dynamic Parameters of the Machines” (not shown) that has the same structure as the table “Q.” The computer 17 then moves on to step 203.

In step 203, the computer 17 reads, using suitable sensors (not shown), the “NbParam_{P}” new values of the dynamic parameters “q_{P}” of the actual machine “P”. The computer 17 stores these values in the corresponding positions of the line of number “P” of the “Table Q of the Dynamic Parameters of the Machines” shown in FIG. 17. With the example of the worksite shown in FIG. 1, the parameters “q_{P.1}” “q_{P.2},” and “q_{P.3}” that are stored in the line of number “P” of the table “Q” above are respectively the dynamic parameters d, g_{P} and h_{P} described above. The computer 17 then moves on to step 204.

In step 204, the computer 17 calls the subroutine “CalculQpa,” which will be described below in relation to FIG. 3, for calculating the amounts to be passed through prior to stopping “QPA_{P}” corresponding to the dynamic parameters “q_{P}” of the actual machine “P”. The computer 17 then moves on to step 205.

In step 205, the computer 17 calls the machine modeling subroutine “ModelisationEngin,” which will be described below in relation to FIG. 4, for machine “P,” then it moves on to step 206.

In step 206, the computer 17 initializes at 0 the numbers “NbVxy” and “NbVz” of anti-collision vectors respectively in the XY plane and along the Z axis, which will be described below in relation to FIG. 5. Likewise, the computer 17 initializes at 1 the loop index “M” for the opposite machines. The computer 17 then moves on to step 207.

In step 207, the computer 17 tests whether the index “M” is equal to “P.” If the response is positive, the computer 17 moves on to step 211, which will be described below. If the response is negative, i.e., if the machine “M” is not the actual machine “P” controlled by the computer 17, the former moves on to step 208.

In step 208, the computer 17 obtains from the opposite machine “M,” via the network 3, the dynamic parameters “q_{M}” of this machine, and it stores them in the corresponding positions of the line “M” of the “Table Q of the Dynamic Parameters of the Machines.” The computer 17 likewise obtains from the opposite machine “M” the stopping distances “QPA_{M}” that correspond to the q_{M} above, and it stores these distances in the corresponding positions of the line “M” of the “Table QPA of the Amounts to be Passed Through Prior to Stopping the Machines” shown in FIG. 18. The computer 17 then moves on to step 209.

In step 209, the computer 17 calls the machine modeling subroutine “ModelisationEngin,” which will be described below in relation to FIG. 4, for the machine “M,” then it moves on to step 210.

In step 210, the computer 17 calls the anti-collision processing subroutine “TraitementAnticollision,” which will be described below in relation to FIG. 5, for the machines “M” and “P,” then it moves on to step 211.

In step 211, the computer 17 increments the loop index “M” for the opposite machines by one unit, then it moves on to step 212.

In step 212, the computer 17 tests whether the loop index “M” is greater than the total number of machines “NbM.” If the response is negative, the computer 17 returns to step 207, described above. If the response is positive, i.e., if the “NbM” machines have been processed, the computer 17 moves on to step 213.

In step 213, the computer 17 calls the subroutine for generating dynamic cutoffs “GenerationCoupuresDynamiques,” which will be described below in relation to FIG. 11. The computer 17 then moves on to step 214.

In step 214, the computer 17 waits until the time period “At,” which is re-read in step 201, from the beginning of the loop begun in step 202, elapses. The object of this waiting is to allow a network bandwidth that is adequate for the other machines and also to see to it that a constant time interval “At” elapses between two successive readings of the dynamic parameters of the machine “P.” Once this predefined time period “At” has elapsed, the computer 17 returns to step 202, described above.

In referring more particularly to FIG. 3, the subroutine “CalculQpa” that appears in step 204 of FIG. 2 will now be described.

This subroutine calculates the amounts to be passed through prior to stopping “QPAp” for the “NbParam_{P}” dynamic parameters of the actual machine “P”. These “QPA” values represent the amounts of movement, measured in the same units as the corresponding “q_{P}” parameters that are necessary for stopping the movement of the machine “P” according to the degree of freedom that is considered.

In the preferred embodiment of the invention, the distance to be passed through prior to stopping for each of the “NbParam_{M}” dynamic parameters “q_{M}” of the machine “M” is modeled as being the product of a coefficient “c_{M,i},” that is selected in a conservative manner, by the rate of variation of the single dynamic parameter “q_{M,i}.”

However, in this embodiment, the sensors that are used provide only the current values of the dynamic parameters and not the desired rates of variation. To solve this problem, the computer 17 that implements the process of the invention digitally estimates the rate of variation of each dynamic parameter as being the ratio between the difference of the last two values measured and the constant time period “At” that separates these two successive measurements.

The subroutine “CalculQpa” begins in step 301 of FIG. 3, where the computer 17 initializes the loop index “i” at the value 1. The computer 17 then moves on to step 302.

In step 302, the computer 17 calculates the value “QPA_{P,i}” by the formula “c_{P},i⁸(q_{P,i}−q′P,i)/At,” in which “cP,i” is a constant re-read in step 201 of FIG. 2, where “qP,i” and q′P,i” respectively represent the last and next-to-last value measured of the dynamic parameter of number “i” of the machine “P,” and where “At” is the constant time period described above in relation to FIG. 2. Consequently, the amount “(qP,i−q′P,i)/Δt” represents a value that is digitally close to the average rate of variation of the parameter “qP,i” of the machine “P” for the period “At.” The computer 17 stores the value “QPAP,i” that is thus calculated in the corresponding position of the table “QPA Table of Amounts to Pass Through Prior to Stopping the Machines” shown in FIG. 18, then it moves on to step 303.

In step 303, the computer 17 increases the loop index “i” by one unit, then it moves on to step 304.

In step 304, the computer 17 tests whether the loop index “i” is greater than the number of dynamic parameters “NbParam_{P}” of the machine “P.” If the response is negative, the computer 17 returns to step 302, described above. If the response is positive, i.e., if the “NbParam,” “QPA_{P}” values, have been calculated for the “NbParam_{P}” dynamic parameters “q_{P}” of the machine “P,” then the subroutine “CalculQpa” is terminated.

By referring more particularly to FIG. 4, the subroutine “ModelisationEngin” that appears in steps 205 and 209 of FIG. 2 will now be described.

The subroutine “ModelisationEngin” receives in a parameter the number “M” of the machine to be modeled. This means that the value that is denoted as “M” in the subroutine “ModelisationEngin” will have the value “P” of the calling program if this subroutine was called from step 205 of FIG. 2 and will have the value “M” of the calling program if this subroutine was called from step 209 of FIG. 2.

The function of the subroutine “ModelisationEngin” is to define, for each of the elements “e” of the machine of number “M” that changed to a parameter, a “deformable model” that consists of all of the positions of the space that the element “e” can assume, during variations that are simultaneous, independent and of any type of the “NbParam_{M}” parameters “q_{M}” in their variation intervals “q_{M,i}” with corresponding “q_{M,i}+QPA_{M,i}.” More specifically, the deformable model associated with the element “e” of the machine “M” is a diagonal parallelepiped (AL, BL), where the points AL and BL are respectively minimum and maximum coordinate points during the variation of “NbParam_{M}” parameters “q_{M,i}” of the machine “M” in their respective variation intervals “q_{M,i}” to “q_{M,i}+QPA_{M,i}.”

The fact of considering the case of a simultaneous variation of any type of dynamic parameters is conservative because, in practice, the dynamic parameters q_{M} vary in a very correlated way in the parallelepiped that is defined by their ranges of variation. More specifically, these parameters vary in an essentially linear way along a diagonal of the parallelepiped defined by the variation intervals of the dynamic parameters. However, in the preferred embodiment of the invention, the possibility of a simultaneous variation of any type in the parallelepiped defined by their variation intervals was retained for safety reasons.

In the case of the example of FIG. 1, the coordinates of the end points A and B of all the elements of machines 1, 2 depend only on a single parameter at the same time. Consequently, the minimum values of the coordinates of point A and the maximum values of the coordinates of point B can be obtained by making a single parameter vary at the same time. In a more general case where at least some of the coordinates of the end points A and B would depend on several parameters, it would be necessary to consider all the simultaneous variation combinations of the parameters in question to determine the minimum values of the coordinates of point A and the maximum values of the coordinates of point B.

The subroutine “ModelisationEngin” begins in step 401.

In step 401, the computer 17 initializes at 1 the loop index “e” for the “NbElem_{M}” elements of machine “M,” then it moves on to step 402.

In step 402, the computer 17 initializes the points AL, and BL_{M,e} respectively to points A, and B_{M,e} of the element “e” of the machine “M” by evaluating the corresponding expressions that appear in the “Table for Configuration of Machines” presented in FIG. 16, for the current values of “NbParam_{M}” parameters “q_{M,i}” of the machine M. The computer 17 then moves on to step 403.

In step 403, the computer 17 initializes at 1 the loop index “i” for the “NbParam_{M}” parameters of the machine “M,” then it moves on to step 404.

In step 404, the computer 17 first of all increases the parameter “q_{M,i}” of the amount “QPA_{M,i}.” Then, it calculates each of the local coordinates of point AL_{M,e} as the minimum of the current value of this coordinate of AL_{M,e} and of the corresponding value obtained for the parameter q_{M,i} increased by the amount QPA_{M,i} by using the corresponding expressions of coordinates of points A_{M,e} of the element “e” of the machine “M” that appears in the “Table for Configuration of Machines” presented in FIG. 16.

In an analogous manner, the computer 17 calculates each of the local coordinates of the point BL_{M,e} as the maximum of the current value of this coordinate of BL_{M,e} and of the corresponding value obtained for the parameter “q_{M,i}” increased by the amount “QPA_{M,i}” by using the corresponding expressions of the coordinates of the points B_{M,e} of the element “e” of the machine “M” that appears in the “Table of Configuration of Machines” presented in FIG. 16. The computer 17 then restores the parameter “q_{M,i}” to its initial value, i.e., it reduces the parameter “q_{M,i}” by the amount “QPA_{M,i}.” The computer 17 then moves on to step 405.

In step 405, the computer 17 increases the loop index “i” by one unit, then it moves on to step 406.

In step 406, the computer 17 tests whether the loop index “i” is greater than the number of dynamic parameters “NbParam_{M}” of the machine “M.” If the response is negative, the computer 17 returns to step 404, described above. If the response is positive, i.e., if the “NbParam_{M}” parameters “q_{M,i}” have been processed, then the computer 17 moves on to step 407.

In step 407, the computer 17 increases the loop index “e” by one unit, then it moves on to step 408.

In step 408, the computer 17 tests whether the loop index “e” is greater than the number of elements “NbElem_{M}” of the machine “M.” If the response is negative, the computer 17 returns to step 402, described above. If the response is positive, i.e., if the “NbElem_{M}” elements of machine “M” have been processed, then the computer 17 moves on to step 410.

In step 410, the computer 17 initializes at 1 the loop index “e” for the “NbElem_{M}” elements of the machine “M,” then it moves on to step 411.

In step 411, the computer 17 calculates the coordinates of the end points AG_{M,e} and BG_{M,e} of the element “e” of the machine “M” in the overall reference of the worksite from the coordinates of points AL and BL_{M,e} in the local reference of the machine “M.” Taking into account that, in the example that is considered, the references R and R₂ of the machines 1, 2 are obtained by translation of the overall reference of the worksite, the coordinates of the end points AG_{M,e} and BG_{M,e} of the element “e” of the machine “M” in the overall reference of the worksite are obtained simply by adding the coordinates of the origin R_{M} of the reference of the machine “M” to the coordinates of the points AL_{M,e} and BL_{M,e} in the local reference of the machine “M.” The computer 17 then moves on to step 412.

In step 412, the computer 17 increases the loop index “e” by one unit, then it moves on to step 413.

In step 413, the computer 17 tests whether the loop index “e” is greater than the number of elements “NbElem_{M}” of the machine “M.” If the response is negative, the computer 17 returns to step 411, described above. If the response is positive, i.e., if the overall coordinates of “NbElem_{M}” elements of the machine “M” have all been calculated, the subroutine “ModelisationEngin” that appears in steps 205 and 209 of FIG. 2 is then terminated.

The results that are calculated in step 411 are stored in the “NbElem_{M}” lines corresponding to the “NbElem_{M}” elements of the machine of number “M” of the “Table of Deformable Models of the Elements of Machines” shown in FIGS. 22A and 22B.

By referring more particularly to FIG. 5, the subroutine “TraitementAnticollision” that appears in step 210 of FIG. 2 will now be described.

The subroutine “TraitementAnticollision” receives a parameter “M” that indicates the number “M” of the opposite machine for which the anti-collision processing is to be carried out with the actual machine of number “P.” The number “P” is the one that is described above in relation to the FIG. 2. The subroutine “TraitementAnticollision” begins in step 501.

In step 501, the computer 17 initializes at 1 the loop variable “E_{P}” that describes the numbers of elements of the actual machine of “P”, then it moves on to step 502.

In step 502, the computer 17 initializes at 1 the loop variable “E_{M}” that describes the numbers of elements of the opposite machine “M,” then it moves on to step 503.

In step 503, the computer 17 calls the function “AjoutsVz” with the arguments “E_{p,i},” “M,” and “E_{M“}” This function, which will be described below in relation to FIG. 6, returns the Boolean value “true” if it added new anti-collision vectors to the table “Vz” (not shown) of anti-collision vectors along the Z axis.

If at least one anti-collision vector was added by the function “AjoutsVz”, i.e., if there exists a risk of collision along the Z axis because of too large a vertical proximity between the machines “P” and “M,” the computer 17 moves on to step 504, described

[symbol]

below. If no anti-collision vector has been added along the Z-axis, the computer 17 moves on to step 511, which will be described below, which means that it skips any search for a collision in the XY plane, because such a collision cannot occur because of an adequate vertical distance between the machines “P” and “M.”

In step 504, the computer 17 initializes at 1 the index “K_{P}” of the points of the rectangular base of the element “E_{P}” of the machine “P,” then it moves on to step 505. The index “K_{P}” assumes the values 1, 2, 3 and 4 respectively for the points of coordinates (X_{AL, P,Ep}, Y_{AL,P,Ep}), (X_{BL,P,Ep}, Y_{AL,P,Ep}), (X_{BL,P,Ep}, Y_{BL,P,Ep}) et (X_{AL,P,Ep}, Y_{BL,P,Ep}).
[and]

In step 505, the computer 17 initializes at 1 the “K_{M}” index of the points of the rectangular base of the element “E” of the machine “M,” then it moves on to step 506. The “K_{M}” index assumes the values of 1, 2, 3 and 4 respectively for the points of coordinates (X_{AL,M,Em}, Y_{AL,M,Em}), (X_{BL,M,Em}, Y_{AL,M,Em}), (X_{BL,M,Em}, Y_{BL,M,Em}) et (X_{AL,M,Em}, Y_{BL,M,Em}).
[and]

In step 506, the computer 17 calls the subroutine “AjoutsVxy,” which will be described below in relation to FIG. 8, with the arguments “E_{P},” “K_{P},” “M,” “E_{M}” and “K_{M}.” It then moves on to step 507.

In step 507, the computer 17 increases the loop index “K_{M}” by one unit for the points of the rectangular base of the element “E” of the machine “M,” then it moves on to step 508.

In step 508, the computer 17 tests whether the loop index “K_{M}” is greater than 4. If the response is negative, the computer returns to step 506, described above. If the response is positive, i.e., if the four points of the rectangular base of the element “E_{M}” of the machine “M” have been processed, the computer moves on to step 509.

In step 509, the computer 17 increases the loop index “K_{P}” by one unit for the points of the rectangular base of the element “E_{P}” of the machine “P,” then it moves on to step 510.

In step 510, the computer 17 tests whether the loop index “KP” is greater than 4. If the response is negative, the computer returns to step 505, described above. If the response is positive, i.e., if the four points of the rectangular base of the element “EP” of the machine “P” have been processed, the computer moves on to step 511.

In step 511, the computer 17 increases the loop index “E_{M}” by one unit for the elements of the machine “M,” then it moves on to step 512.

In step 512, the computer 17 tests whether the loop index “E_{M}” is greater than the number “NbElem_{M}” of elements of the machine “M.” If the response is negative, the computer 17 returns to step 503, described above. If the response is positive, i.e., if the “NbElem_{M}” elements of the machine “M” have been processed, the computer moves on to step 513.

In step 513, the computer 17 increases the loop index “E_{P}” by one unit for the elements of the machine P, then it moves on to step 512.

In step 512, the computer 17 tests whether the loop index “E_{P}” is greater than the number of NbElem_{P} elements of the machine “P.” If the response is negative, the computer 17 returns to step 502, described above. If the response is positive, i.e., if the “NbElem_{P}” elements of the machine “P” have been processed, the subroutine “TraitementAnticollision” is then terminated.

By referring more particularly to FIG. 6, the function “AjoutsVz” that appears in step 503 of FIG. 5 will now be described.

From the calling program, the function “AjoutsVz” receives the parameters “e,” “M” and “f” indicating respectively the number of the element to be processed in the machine “P,” the number “M” of the opposite machine to be processed, and the number “f” of the element to be processed in the machine “M.” Its object is to add an anti-collision vector along the Z axis to the table “Vz” (not shown) if there is a risk of collision along the Z axis between the elements “e” and “f” of the respective machines “P” and “M.”

This function returns a Boolean indicator that has the value “true” if it added at least one anti-collision vector to the table “Vz” of the anti-collision vectors along Z, and “false” in the opposite case. The function “AjoutsVz” begins in step 601.

In step 601, the computer 17 initializes at the Boolean value “false” the “cr” variable that contains the Boolean value that will be returned via the function “AjoutsVz”, then it moves on to step 602.

In step 602, the computer 17 tests whether the lower side of the element “f” of the machine “M” is lower than the upper side of the element “e” of the actual machine “P,” increased by the safety distance “DS” previously described in relation to FIG. 2. If the response is negative, then the computer 17 moves on to step 604, described below. If the response is positive, then there is a risk of collision between the upper portion of the element “e” of the machine “P” and the lower portion of the element “f” of the machine “M,” and the computer 17 then moves on to step 603.

In step 603, the computer 17 calls the subroutine “AjoutVZ,” which will be described below in relation to FIG. 7, with the arguments “e,” “true” and “Z_{BG,M,f}-Z_{AG,P.e}”. The “true” argument above indicates that the upper face of the element “e” of the machine “P” is the one concerned by the risk of collision. Furthermore, the computer 17 stores the Boolean value “true” in the variable “cr” to indicate that an anti-collision vector in Z has been added. It then moves on to step 604.

In step 604, the computer 17 tests whether the upper side of the element “f” of the machine “M” is greater than the lower side of the element “e” of the actual machine “P,” reduced by the safety distance “DS.” If the response is negative, then the computer 17 returns the value “cr” to the calling program; the subroutine “AjoutsVz” is then terminated. If the response is positive, then there is a risk of collision between the lower portion of the element “e” of the machine “P” and the upper portion of the element “f” of the machine M, and the computer 17 then moves on to step 605.

In step 605, the computer 17 calls the function “AjoutVZ” with the arguments “e,” “false” and The “false” argument above indicates that the lower face of the element “e” of the machine “P” is the one concerned by the risk of collision. Furthermore, the computer 17 stores the Boolean value “true” in the variable “cr” to indicate that an anti-collision vector in Z was added. The computer 17 then returns the value “cr” to the calling program, and the subroutine “AjoutsVz” is then terminated.

By referring more particularly to FIG. 7, the subroutine “AjoutVz” that appears in steps 603 and 605 of FIG. 6 will now be described.

The subroutine “AjoutVxy” receives the parameters “e,” “h,” and “z” changed by the calling program. It has as its function to add an anti-collision vector to the table “Vz” (not shown) with three columns of anti-collision vectors parallel to the Z axis.

The subroutine “AjoutVz” consists of a single step 701.

In this step, the computer 17 increases the number “NbVz” of anti-collision vectors along the Z axis by one unit, then it stores the three parameters “e,” “h,” and “z” that were passed to it by the calling program in the three positions of the corresponding “NbVz” line of the table “Vz”.

The subroutine “AjoutVz” is then terminated.

By referring more particularly to FIG. 8, the subroutine “AjoutsVxy” that appears in step 506 of FIG. 5 will now be described.

The subroutine “AjoutsVxy” receives from the calling program the parameters “e,”, “k,” “M,” “f” and “l,” and its function is to determine the anti-collision vectors of a length less than “DS” that are associated with the point “k” of the base in the XY plane of the element “e” of the machine “P,” with regard to the segment of the base of the element “f” of the machine “M” beginning at the point of number “1” of this base. These vectors are the vectors SM, SH and SM₁ that appear in FIG. 15, where S is the point of number “k” of the element, M₀ is the point of number “1” of the element “f” of the machine “M,” M₁ is the point following M₀ on the closed contour of the base of the element “P” of the machine “M,” and H is the foot of the perpendicular line originating from point S lowered to the segment M₀M₁.

The subroutine “AjoutsVxy” begins in step 801.

In step 801, the computer 17 finds the coordinates “x_{P}” and “y_{P}” of the point S of number “k” in the element “e” of the machine “P” using the subroutine “XY” that will be described below in relation to FIG. 9. Likewise, it finds the coordinates “X_{M0}” and “Y_{M0}” of the first point M₀ of number “1” of the segment of the flat base of the element “f” of the machine “M” using the same subroutine “XY.”

The computer 17 determines the number of the second point M₁ of the segment of the base of the element “f” of the machine “M” using the formula “mod(1,4)+1” where “mod” represents the modulo function, or remainder from the division of its first argument by the second. The result of this formula is equal to 1 if the variable “1” is equal to 4 and “1+1” in the opposite case. Consequently, taking into account the convention of numbering points described above in relation to step 505 of FIG. 5, the point number thus determined is the point M, following the point M₀ on the closed contour of the base of the element “f” of the machine “M.”

The computer 17 then finds, using this number, the coordinates “x_{M1}” and “y,” of the second point M₁ of the segment of the flat base of the element “f” of the machine “M” with the same subroutine “XY,” then it moves on to step 802.

In step 802, the computer 17 tests whether this Euclidean distance in the XY plane between the point S and the point M₀ of respective coordinates “x_{P},” “y,” and “x_{M0},” “y_{M0}” determined above is less than the safety distance “DS.” If the response is negative, then the computer moves on to step 804 described below. If the response is positive, then there is a risk of collision between the point S and the segment M₀M₁, and the computer moves on to step 803.

In step 803, the computer 17 calls the subroutine “AjoutVxy,” which will be described below in relation to FIG. 10, with the arguments “e,” “k,” “x_{M0}-x,” and “y_{M′}-y,” and then the computer 17 moves on to step 804.

In step 804, the computer 17 tests whether the Euclidean distance in the XY plane between the point S of coordinates “x” and “y,” and the point M₁ of coordinates “x_{M1}” and “y″” determined below is less than the safety distance “DS.” If the response is negative, then the computer moves on to step 806, described below. If the response is positive, then there is a risk of collision between the point S and the segment M₀M₁, and the computer moves on to step 805.

In step 805, the computer 17 calls the subroutine “AjoutVxy” with the arguments “e,”, “k,”, “x_{M1}-x_{P}” and “y_{M′}-y,” then the computer 17 moves on to step 806.

In step 806, the computer 17 calculates the parameter “λ” defining the point H in the parametric equation of the segment of a line M₀M₁:
SH=(1−λ)*SM0+*SM1, 0≦λ≦1

The vector SH will be perpendicular to the vector M₀M₁ if and only if the scalar product of these two vectors is zero. Consequently, an elementary development for one skilled in the art shows that the segment SH is perpendicular to the segment M₀M₁ for the value of “λ” that appears in step 806. The computer 17 then moves on to step 807.

In step 807, the computer 17 tests whether the value of “λ” determined in step 806 is between 0 and 1. If the response is negative, then the point H is located beyond segment M₀M₁, which means that the point S is closer by one of points M₀ or M₁ than any other point of the segment M₀M₁ and that, consequently, there is no risk of collision between the point S and a point inside the segment. The subroutine “AjoutsVxy” is then terminated. If the response is positive, then the computer 17 moves on to step 808.

In step 808, the computer 17 calculates the coordinates “hₓ” and “h_{y}” that are obtained by replacing, in the parametric equation of the segment SH, the parameter “λ” by the value that is obtained in step 806. It then moves on to step 809.

In step 809, the computer 17 tests whether the length of the segment SH is less than the safety distance “DS.” If the response is negative, then there is no risk of collision, and the subroutine “AjoutsVxy” is terminated. If the response is positive, then the computer 17 moves on to step 810.

In step 810, the computer 17 calls the subroutine “AjoutVxy” with the arguments “e,” “k,” “hₓ,” and “h_{Y},” then the subroutine “AjoutsVxy” is terminated.

By referring more particularly to FIG. 9, the subroutine “XY” that appears in step 801 of FIG. 8 will now be described.

The subroutine “XY” receives the parameters “M,” “e,” “k,” “x,” and “y” of the calling program. It has as its function finding the coordinates “x” and “y” of the number point “k” in the flat base of the element of number “e” of the machine of number “M.” The subroutine “XY” begins in step 901.

In step 901, the computer 17 tests whether the value of the parameter “k,” indicating the number of the point in the base of the element “e” of the machine “P” is equal to 1 or 4. If the response is negative, the computer moves on to step 903, described below, if not, it moves on to step 902.

In step 902, the computer 17 assigns the minimum value “X_{AG,M,e}” corresponding to the case “k=1 or k=4,” taking into account the numbering agreement defined in step 505 of FIG. 5, to the variable “x” changed to a parameter, then it moves on to step 904.

In step 903, reached when the response to the test of step 901 is negative, the computer 17 assigns the maximum value “X_{BG,M,e}” to the variable “x,” then it moves on to step 904.

In step 904, the computer 17 tests whether the value of the parameter “k,” indicating the number of the point S in the base of the element “e” of the machine “P,” is equal to 1 or 2. If the response is negative, the computer moves on to step 906, described below, if not it moves on to step 905.

In step 905, the computer 17 assigns the minimum value “y_{AG,M,e}” corresponding to the case “k=1 or k=2,” taking into account the numbering agreement defined in step 505 of FIG. 5, to the variable “y” changed to a parameter. The subroutine “XY” is then terminated.

In step 906, reached when the response to the test of step 904 is negative, the computer 17 assigns the maximum value “Y_{BG,M,e}” to the variable “y.” The subroutine “XY” is then terminated.

By referring more particularly to FIG. 10, the subroutine “AjoutVxy” that appears in steps 803, 805 and 810 of FIG. 8 will now be described.

The subroutine “AjoutVxy” receives the parameters “e,” “k,” “x” and “y” changed by the calling program. It has the function of adding an anti-collision vector to the table “Vxy” (not shown) with four columns of anti-collision vectors in the XY plane.

The subroutine “AjoutVxy” consists of the single step 1001.

In this step, the computer 17 increases the number “NbVxy” of anti-collision vectors in the XY plane by one unit, then it stores the four parameters “e,” “k”, “x” and “y” that changed it to parameters by the calling program in the four positions of the corresponding line “NbVxy” of the table “Vxy.”

The subroutine “AjoutVxy” is then terminated.

By referring more particularly to FIG. 11, the subroutine “GenerationCoupuresDynamiques” that appears in step 213 of FIG. 2 will now be described.

The function of this subroutine is to determine what degrees of freedom of the machine “P,” and in what direction, should be stopped to prevent increasing the anti-collision vectors determined above, i.e., for stopping the movements before a collision occurs.

The subroutine “GenerationCoupuresDynamiques” begins in step 1101.

In step 1101, the computer 17 tests whether the numbers of anti-collision vectors “NbVxy” in the XZ plane and “NbVz” on the Z axis are both zero. If the response is positive, i.e., if there are no anti-collision vectors and therefore no risk of collision, the subroutine “GenerationCoupuresDynamiques” is terminated. If the response is negative, then the computer 17 moves on to step 1102.

In step 1102, the computer 17 generates an alarm, visual or audible, for the operator of the actual machine “P” that it controls, then it moves on to step 1103.

In step 1103, the computer 17 starts again at 0 the dynamic cutoffs in the positive direction “C⁺” and in the negative direction “C⁻” for the “NbParam_{P}” degrees of freedom of the actual machine “P,” then it moves on to step 1104.

In step 1104, the computer 17 initializes the loop index “n” of the anti-collision vectors in the XY plane at the value 1, then it moves on to step 1105.

In step 1105, the computer 17 calls the subroutine for determining dynamic cutoffs in the XY plane “CoupuresDyanmiquesVxy,” which will be described below in relation to FIG. 12, by passing to it as an argument the number “n” of the anti-collision vector “Vxy” to be processed. The computer 17 then moves on to step 1106.

In step 1106, the computer 17 increments the loop index “n” by one unit, then it moves on to step 1107.

In step 1107, the computer 17 tests whether the loop index “n” is greater than the number “NbVxy” of anti-collision vectors “Vxy” in the XY plane. If the response is negative, the computer 17 returns to step 1105, described above, if not, i.e., if the “NbVxy” anti-collision vectors “Vxy” in the XY plane have been processed, the computer 17 moves on to step 1108.

In step 1108, the computer 17 initializes the loop index “n” of the anti-collision vectors along the Z axis at the value 1, then it moves on to step 1109.

In step 1109, the computer 17 calls the subroutine “CoupuresDyanmiquesVz” that determines the dynamic cutoffs along the Z axis, which will be described below in relation to FIG. 13, by passing to this subroutine an argument that consists of the number “n” of the anti-collision vector “Vz” to be processed. The computer 17 then moves on to step 1110.

In step 1110, the computer 17 increments the loop index “n” by one unit, then it moves on to step 1111.

In step 1111, the computer 17 tests whether the loop index “n” is greater than the number “NbVz” of anti-collision vectors “Vz” parallel to the Z axis. If the response is negative, the computer 17 returns to step 1109, described above, if not, i.e., if all the anti-collision vectors “Vz” parallel to the Z axis have been processed, the computer 17 moves on to step 1112.

In step 1112, the computer 17 calls the subroutine “EnvoiCoupuresDyanmiques,” which will be described below in relation to FIG. 14, then the subroutine “GénérationCoupuresDynamiques” is terminated.

By referring more particularly to FIGS. 12 and 15, the subroutine “CoupuresDynamiquesVxy” that appears in step 1105 of FIG. 11 will now be described.

The function of this subroutine is to generate the dynamic cutoffs that are necessary for the vector “Vxy” of number “n” changed to a parameter, for the “NbParam_{P}” parameters “q,” of the actual machine “P,” and in the two directions of movement of the degree of freedom of the machine “P” associated with each of these parameters.

The subroutine “CoupuresDynamiquesVxy” begins with the step of 1201.

In step 1201, the computer 17 initializes the temporary variable “e” at the value found in the first position of the line “n” of the table “Vxy,” i.e., the variable “e” receives the number of the element of the machine “P” to which belongs the point S of origin of the anti-collision vector “n,” such that it was saved in step 1001 of FIG. 10. Likewise, the computer 17 initializes a temporary variable “k” at the value found in the second position of the line “n” of the table “Vxy,” i.e., the variable “k” receives the number, in the element “e” of the machine “P,” of the point S of origin of the anti-collision vector n.

The computer 17 then calls the subroutine “XY,” described above in relation to FIG. 9, with the arguments “P,” “e,” “k,” “x” and “y,” which has the result of initializing the variables “x” and “y” to the values of the coordinates XY of the point “k” of the base of the element “e” of the machine “P.” In other words, the computer 17 thus finds the coordinates of the point S of origin of the anti-collision vector “VXyₙ,” for the current values of the parameters “q_{P}” of the machine “P.”

The computer 17 also initializes the loop index “i” at the value 1, then it moves on to step 1202.

In step 1202, the computer 17 adds the positive amount “ε_{p,i}” that was re-read in step 201 of FIG. 2, to the value of the parameter “q_{P,i}.” The value “ε_{P,i}” associated with the parameter “q_{P,i}” is a predetermined value, selected so as to be low enough so that the movements of the elements of the machine “P” associated with this increment of the parameter “q_{P,i}” remain small, while ensuring an adequate digital precision for the subsequent calculations.

The computer 17 then finds the coordinates “x′” and “y′” of the point S′ of origin of the anti-collision vector “Vxyₙ” for the value “q_{P,i}+ε_{P,i}” of the parameter “i” of the machine “P,” by calling the subroutine “XY” with the parameters “P,” “e,” “k,” “x′” and “y′.” The computer then restores the parameter “q_{P,i}” to its current value by subtracting the amount “ε_{P,i}” from “q_{P,i},” then it calculates the scalar product “PS” of the vector SS′ and of the anti-collision vector “Vxyₙ.” The computer 17 then moves on to step 1203.

In step 1203, the computer 17 tests whether the scalar product “PS” determined in step 1202 is positive. If the response is negative, then the computer 17 moves on to step 1205, described below. If the response is positive, then a positive variation of the parameter “q_{P,i}” will tend to reduce the anti-collision vector “VXYₙ,” i.e., to increase the risk of a collision. In this case, the computer 17 moves on to step 1204, where the cutoff indicator “C′s” is positioned at the value “true” to indicate that the movement according to the degree of freedom “i” of the machine “P” should not be permitted in the positive direction. The computer 17 then moves on to step 1205.

In step 1205, the computer 17 tests whether the scalar product “PS” determined in step 1202 is negative. If the response is negative, then the computer 17 moves on to step 1207 described below. If the response is positive, then a negative variation of the parameter “q_{P,i}” will tend to reduce the anti-collision vector “Vxyₙ,” i.e., to increase the risk of a collision. In this case, the computer 17 moves on to step 1206, where the cutoff indicator “C′₁38 is positioned at the value “true” to indicate that the movement “i” of the machine “P” in the negative direction should be cut off. The computer 17 then moves on to step 1207.

In step 1207, the computer 17 increases the loop index “i” by one unit, then it moves on to step 1208.

In step 1208, the computer 17 tests whether the loop index “i” is greater than the number “NbParam_{P}” of parameters of the machine “P.” If the response is negative, then the computer 17 returns to step 1202, described above. If the response is positive, i.e., if the “NbParm_{P}” parameters “q_{P}” of the actual machine “P” were processed, the subroutine “CoupuresDynamiques Vxy” is terminated.

By referring more particularly to FIG. 13, the subroutine “CoupuresDynamiquesVz” that appears in step 1109 of FIG. 11 will now be described.

The function of this subroutine is to generate the necessary dynamic cutoffs for the vector Vz of number “n” changed to a parameter, for the “NbParam_{P}” parameters “q_{P}” of the actual machine “P,” and in the two directions of movement of the degree of freedom of the machine “P” associated with each of these parameters.

The subroutine “CoupuresDynamiquesVz” begins in step 1301.

In step 1301, the computer 17 initializes the temporary variable “e” at the value found in the first position of the line “n” of the table “Vz,” i.e., the variable “e” receives the number of the element of the machine “P” to which the point S of origin of the anti-collision vector “n,” as it was saved in step 701 of FIG. 7, belongs. The computer 17 also initializes the loop index “i” at the value 1, then it moves on to step 1302.

In step 1302, the computer 17 tests the value of the Boolean variable stored in the second column of the line “n” of the table of anti-collision vectors “Vz.” This value, stored in step 701 of FIG. 7, has the Boolean value “true” if the risk of collision concerns the upper face of the element “e,” and the Boolean value “false” if the risk of collision concerns the lower face of the element “e.” If the value “VZ_{n,2}” has the Boolean value “true,” then the computer 17 moves on to step 1304, which will be described below; otherwise, the computer 17 moves on to step 1303.

In step 1303, reached if the variable “Vz_{n,2}” has the Boolean value “false,” i.e., if the risk of collision indicated by “Vzₙ” concerns the lower face of the element “e” of the machine “P,” the computer 17 initializes the temporary variable “z,” representing the side of the point S of origin of the anti-collision vector “Vzₙ,” at the value of the side “z_{AG,P,e}” of the lower face of the element “e” of the machine “P.” The computer 17 then adds the positive amount “ε_{P,i}”, which was re-read in step 201 of FIG. 2, to the value of the parameter “q_{P,i}.” The value “ε_{P,i}” that is associated with the parameter “q_{P,i}” is the same as the one that is described in relation to step 1202 of FIG. 12. The computer 17 then initializes the temporary variable “z′,” representing the side of the point S′ of origin of the anti-collision vector “Vzₙ” for the value “q_{P,i}+ε_{P,i} of the parameter “i” of the machine “P,” at the value of the side “z_{AG,P,i}” of the lower face of the element “e” of the machine “P” obtained for the value “q_{P,i}+ε_{P,i} of the parameter “i” of the machine “P.” The computer then restores the parameter “q_{P,i}” to its initial value by subtracting the amount “ε_{P,i}” from “q_{P,i}.” The computer 17 then moves on to step 1305.

In step 1304, reached if the variable “Vz_{n,2}” has the Boolean value “true,” i.e., if the risk of collision indicated by “Vz” concerns the upper face of the element “e” of the machine “P,” the computer 17 initializes the temporary variable “z,” which represents the side of the point S of origin of the anti-collision vector “Vzₙ,” at the value of the side “z_{BG,P,e}” of the upper face of the element “e” of the machine “P.” The computer 17 then adds the amount “ε_{P,i}” to the value of the parameter “q_{P,i}.” The computer 17 then initializes the temporary variable “z,” representing the side of the point S′ of origin of the anti-collision vector “VZₙ” for the value “q_{P,1}+ε_{P,i}” of the parameter “i” of the machine “P,” at the value of the side “z_{AG,P,e}” of the lower face of the element “e” of the machine “P” that is obtained for the value “q_{P,1}+ε_{P,i}” of the parameter “i” of the machine “P.” The computer then restores the parameter “q_{P,i}” to its initial value by subtracting the amount “ε_{P,i}” from “q_{P,i}.” The computer 17 then moves on to step 1305.

In step 1305, the computer 17 tests whether the product “(z′−z)*Vz_{n,3},” where “z” and “z′” are the values that are determined in step 1302 or 1303 and “Vz_{n,3}” is the length of the anti-collision vector “Vzₙ” as determined in step 701 of FIG. 7, is positive. If the response is negative, then the computer 17 moves on to step 1307, which will be described below. If the response is positive, then the vector SS′ has the same direction as the anti-collision vector “Vzₙ,” i.e., a positive variation of the parameter “q_{P,i}” will tend to reduce the anti-collision vector “Vzₙ,” therefore to increase the risk of a collision. Consequently, the computer 17 moves on to step 1306, where the cutoff indicator “C⁺ᵢ” is positioned at the value “true” to indicate that the movement “i” of the machine “P” should not be allowed in the positive direction of the parameter “q_{P,i}.” The computer 17 then moves on to step 1307.

In step 1307, the computer 17 tests whether the product “(z′−z)*Vz_{n,3}” is negative. If the response is negative, then the computer 17 moves on to step 1309, which will be described below. If the response is positive, then the vector SS′ has a direction that is opposite to the one of the anti-collision vector “Vzₙ,” i.e., a negative variation of the parameter “q_{P,i}” will tend to reduce the anti-collision vector “Vzₙ,” therefore to increase the risk of a collision. Consequently, the computer 17 moves on to step 1308, where the cutoff indicator “Cᵢ” is positioned at the value “true” to indicate that the movement “i” of the machine “P in the negative direction of the parameter “q_{P,i}” is not to be allowed. The computer 17 then moves to step 1309.

In step 1309, the computer 17 increases the loop index “i” by one unit, then it moves on to step 1310.

In step 1310, the computer 17 tests whether the loop index “i” is greater than the number “NbParam_{P}” of parameters of the machine “P.” If the response is negative, then the computer 17 returns to step 1302, described above. If the response is positive, i.e., if the “NbParm_{P}” parameters “q_{P}” of the actual machine “P” have been processed, the subroutine “CoupuresDynamiquesVz” is terminated.

By referring more particularly to FIG. 14, the subroutine “EnvoiCoupuresDynamiques” that appears in step 1112 of FIG. 11 will now be described.

The subroutine “EnvoiCoupuresDynamiques” begins in step 1401.

In step 1401, the computer 17 initializes the loop index “i” at the value 1, then it moves on to step 1402.

In step 1402, the computer 17 tests whether the variable C⁺ᵢ” has the Boolean value “true.” If the response is negative, then the computer 17 moves on to step 1404, which will be described below. If the response is positive, the computer moves on to step 1403.

In step 1403, reached if the variable “C⁺ᵢ” has the value “true,” i.e., if the computer 17 determined by means of the process described above that the movement of the degree of freedom “i” of the machine “P” had to be forbidden in the direction of positive variation of the parameter “q_{P,i},” the computer 17 sends an order for stopping movement in the positive direction to the actuator “i” in question of the machine “P.” The computer 17 then moves on to step 1404.

In step 1404, the computer 17 tests whether the variable “C⁻ᵢ” has the Boolean value “true.” If the response is negative, then the computer 17 moves on to step 1406, which will be described below. If the response is positive, the computer moves on to step 1405.

In step 1405, reached if the variable “C⁻ᵢ” has the value “true,” i.e., if the computer 17 determined, by means of the process described above, that the movement of the degree of freedom “i” of the machine “P” should be forbidden in the direction of negative variation of the parameter “qp_{P,i}” the computer 17 sends an order for stopping movement in the negative direction to the actuator “i” in question of the machine “P.” The computer 17 then moves on to step 1406.

In step 1406, the computer increases the loop index “i” by one unit, then it moves on to step 1407.

In step 1407, the computer 17 tests whether the loop index “i” is greater than the number “NbParam_{P}” of parameters of the actual machine P. If the response is negative, the computer 17 returns to step 1402, described above. If the response is positive, i.e., if all the dynamic cutoffs have been sent to the corresponding actuators, then the subroutine “EnvoiCoupuresDynamiques” is terminated.

The program executed by the computer system 27 is similar on all points to the one executed by the computer system 17 above. Consequently, it will not be described.

Above, the preferred embodiment of the process of invention that makes it possible to detect the risks of collision between the elements of the machines on the same worksite was described.

One skilled in the art can easily provide modifications and/or improvements to the above-described embodiment of the process of the invention.

In particular, in a concern for clarity, the example was voluntarily restricted to a simple case that consists of two machines. Likewise, the structures of data of the described example have been simplified, the type of machines processed has been restricted to those with gantry cranes that are modeled as consisting of five parallelepipedic elements, the reference changes have been limited to translations, and the number of dynamic parameters has been limited to three per machine.

In practice, one skilled in the art can easily extend the example that is described to a large number of machines on the same worksite, whereby the elements of the machines can be prismatic, cylindrical, etc. Likewise, the machines that are considered can be of other types: rotary cranes, lifting cranes, rail machines, excavation machines, hand trucks, overhead cranes, etc.; the changes in reference can easily be generalized in the case of any changes in reference, and the number of dynamic parameters of each machine can be reduced or increased based on the type of machine used.

Likewise, in the example presented, the studies on collision risk were limited to pairs of elements wherein each element belongs to a different machine. However, it is perfectly possible to extend the process of the invention to elements that belong to the same machine, for example, to avoid a collision between the load of a crane and elements of the latter.

Consequently, it will be obvious to the reader that the process of the invention is not limited to the description of the embodiment and/or to the example presented above, whereby the process of the invention is limited only by the accompanying claims.

1-36. (canceled)

37. Process for avoiding collisions between at least two elements (11, 12, 13, 14, 15, 16, 21, 22, 23, 24, 25, 26) of at least one lifting machine (1, 2), said elements (11, 12, 13, 14, 15, 16, 21, 22, 23, 24, 25, 26) able to be intrinsic elements of said at least one lifting machine (1, 2) or loads that are transported by said at least one lifting machine (1, 2), said elements (11, 12, 13, 14, 15, 16, 21, 22, 23, 24, 25, 26) being defined by points, said points being able to be known in digital form, said points being able to move simultaneously according to at least one degree of freedom, the amount of movement according to each of said at least one degree of freedom being able to be known in digital form, each of said simultaneous movements requiring a minimum variation of said corresponding degree of freedom prior to stopping, at least one computer-type system (17, 27) being used to store and to process said points and said amounts of movement in digital form, characterized by the fact that a deformable digital model is defined inside of said computer-type system (17, 27) for each of said elements (11, 12, 13, 14, 15, 16, 21, 22, 23, 24, 25, 26) of said machines (1, 2), said deformable model containing all of the positions that the points of said associated element (11, 12, 13, 14, 15, 16, 21, 22, 23, 24, 25, 26) are able to assume during any combination of simultaneous movements according to said at least one degree of freedom during said minimum variations prior to stopping, said at least one computer-type system (17, 27) calculating, for at least one machine (1, 2), a distance between each of said deformable models of said elements (11, 12, 13, 14, 15, 16) of said at least one machine (1, 2) and each of said deformable models of said elements (11, 12, 13, 14, 15, 16, 21, 22, 23, 24, 25, 26) of the same machine (1, 2) or of another machine (1, 2), said at least one computer-type system (17, 27) detecting a risk of collision when at least one of said distances is less than a predefined safety distance.

38. Process according to claim 37, wherein each of said at least one machine (1, 2) comprises a computer-type system (17, 27).

39. Process according to claim 37, wherein said at least one computer-type system (17, 27) comprises at least one display device that makes it possible to display said deformable models for an operator.

40. Process according to claim 37, wherein an alarm is generated by said at least one computer-type system (17, 27) during said detection of said risk of collision.

41. Process according to claim 40, wherein said alarm is an audible alarm.

42. Process according to claim 40, wherein said alarm is a visual alarm.

43. Process according to claim 40, wherein said alarm is designed for at least one of the operators of said at least one machine (1, 2).

44. Process according to claim 37, wherein said minimum variations prior to stopping are determined or measured by said at least one computer system (17, 27).

45. Process according to claim 44, wherein said minimum variations prior to stopping are assigned to a predefined value where it is impossible to determine or to measure said minimum variations prior to stopping.

46. Process according to claim 37, wherein said deformable models are two-dimensional.

47. Process according to claim 37, wherein said deformable models are three-dimensional.

48. Process according to claim 47, wherein said deformable models are approximated by an encompassing prismatic volume that is obtained as the set of points through which a base that consists of a surface element travels during a movement that is not included in said surface.

49. Process according to claim 48, wherein said base is flat.

50. Process according to claim 49, wherein the contour of said flat base is defined by a set of connected segments of a line and arcs.

51. Process according to claim 48, wherein said movement is rectilinear.

52. Process according to claim 51, wherein said rectilinear movement is perpendicular to the plane of said base.

53. Process according to claim 37, wherein at least two computer-type systems (17, 27) are associated respectively with at least two corresponding machines (1, 2) for processing said points and said amounts of movement in digital form.

54. Process according to claim 53, wherein said at least two computer-type systems (17, 27) exchange data in digital form.

55. Process according to claim 54, wherein said data are exchanged by said at least two computer-type systems (17, 27) via a computer-type communication means (3).

56. Process according to claim 55, wherein said computer-type communication means (3) is a computer-type network.

57. Process according to claim 37, wherein said at least one computer-type system (17, 27) can exert control over the variation of at least one degree of freedom of at least one of said at least one machine (1, 2).

58. Process according to claim 57, wherein said control consists of a cutoff of the variation of said at least one degree of freedom.

59. Process according to claim 57, wherein said control consists of a reduction of the rate of variation of said at least one degree of freedom.

60. Process according to claim 59, wherein said speed reduction is inversely proportional to one of said distances calculated in relation to at least one of said machines (1, 2).

61. Process according to claim 37, wherein a simple overall envelope is defined in at least two computer-type systems (17, 27) for at least two corresponding machines (1, 2), whereby any two of said at least two corresponding machines (1, 2) are determined as being unable to collide if their simple overall envelopes present an empty intersection.

62. Process according to claim 61, wherein said simple overall envelope is a prism that is obtained by movement of a basic surface along a path.

63. Process according to claim 62, wherein said basic surface is flat.

64. Process according to claim 63, wherein said flat basic surface is a circular disk.

65. Process according to claim 62, wherein said path is rectilinear.

66. Process according to claim 63, wherein said path is rectilinear and perpendicular to said flat base.

67. Process according to claim 37, wherein at least one of said at least one computer-type system (17, 27) comprises a non-volatile memory.

68. Process according to claim 67, wherein said non-volatile memory stores the configuration of at least one of said machines (1, 2) in digital form.

69. Process according to claim 67, wherein said non-volatile memory is a computer hard disk.

70. System for avoiding collisions between at least two elements (11, 12, 13, 14, 15, 16, 21, 22, 23, 24, 25, 26) of at least one lifting machine (1, 2), said elements (11, 12, 13, 14, 15, 16, 21, 22, 23, 24, 25, 26) able to be intrinsic elements of said at least one lifting machine (1, 2) or loads transported by said at least one lifting machine (1, 2), said elements (11, 12, 13, 14, 15, 16, 21, 22, 23, 24, 25, 26) being defined by points, said points being able to be known in digital form, said points being able to move simultaneously according to at least one degree of freedom, the amount of movement according to each of said at least one degree of freedom able to be known in digital form, each of said simultaneous movements requiring a minimum variation of said corresponding degree of freedom prior to stopping, at least one computer-type system (17, 27) being used to store and to process said points and said amounts of movement in digital form, characterized by the fact that it implements the process according to claim 37.
